(19) United States
(12) Patent Application Publication
(10) Pub. No.: US 2016/0088819 A1
(43) Pub. Date: Mar. 31, 2016

(54) PORTABLE BIRD PERCH ASSEMBLY

(71) Applicants: Bethany SLOAN, Redlands, CA (US); John CASSIDY, Redlands, CA (US); Keith SLOAN, Yucaipa, CA (US)

(72) Inventors: Bethany SLOAN, Redlands, CA (US); John CASSIDY, Redlands, CA (US); Keith SLOAN, Yucaipa, CA (US)

(73) Assignee: POP'S BIRDING CO, LLC, Redlands, CA (US)

(21) Appl. No.: 14/501,682

(22) Filed: Sep. 30, 2014

(51) Int. Cl. A01K 31/12; A01K 39/01

(52) U.S. Cl. CPC A01K 31/12; A01K 39/01

(57) ABSTRACT

A swinging bird perch assembly is provided for birds of various types. The perch assembly includes an arch-shaped frame supporting an elongated rod there between. The frame may be configured as a flat u-shaped lattice structure having a first end attached to a first end of the elongated rod and a second end attached to a second end of the elongated rod. The width of the lattice structure of the frame is adapted to accommodate various birds at one time. An attractant item may dangle from an upper end of the lattice structure. Alternatively, a feeder assembly may be attached to the elongated rod to hold a given quantity of a food source for the bird.

### BACKGROUND

1. Technical Field

The invention relates to bird perches and is more particularly concerned with a portable swinging perch including an attracting dangler and a feeder.

2. Description of the Related Art

All bird species require food, water, shelter and nesting spots. Birders who understand how to attract more specific species such as hummingbirds will create sanctuaries in their backyards to fulfill all those basic bird needs. Hummingbirds are popular backyard birds that are naturally aggressive and territorial about their favorite feeding areas such as feeders and flowerbeds. Many male hummingbirds will find suitable branches nearby to stake out the area so they can more easily chase off competing hummingbirds away from the best feeding areas and nesting sites.

Birders will frequently place perches near a hummingbird feeder to encourage the hummingbird to sit and swing for extended periods of time conveniently adjacent to their source of food. Birders find quite enjoyment in creating these backyard sanctuaries to attract hummingbirds as well as various types of birds that may be observed.

There are various ways to attract a hummingbird such as by planting various specific types of plants or flowers. For example, hummingbirds are attracted to various bright colored tubular flowers like yellow, orange, pink. Bleeding hearts, impatiens, petunias, salvias, bee balm, columbine, cannas, viburnums, honeysuckles and many other flower, tree and shrub species will attract a variety of hummingbirds. While bright colors are very attractive to hummingbirds, an important factor in drawing a hummingbird is to provide flowers that produce plenty of nectar as hummingbirds seek out nectar-rich flowers. Conventionally, commercial nectar concentrates, mixes and/or homemade hummingbird nectar recipes are filled in feeders in an attempt to draw hummingbirds close to a particular location. However, conventional feeders do not include a convenient location for a bird to perch or swing.

### SUMMARY

An object of the present invention is to provide a swinging bird perch assembly. The perch assembly includes an arch-shaped frame supporting an elongated rod there between onto which the bird may perch and swing. The frame may be configured as a flat u-shaped lattice structure having a first lattice end attached to a first end of the elongated rod and a second lattice end attached to a second end of the elongated rod. The width of the lattice structure of the frame is adapted to accommodate various birds at one time. An attractant item may be provided to dangle from an upper end of the lattice structure. Alternatively, a feeder assembly may be attached to the elongated rod to hold a given quantity of a food source for the bird.

This and other objects, features, and/or advantages may accrue from various aspects of embodiments as described in more detail below.

### BRIEF DESCRIPTION OF THE DRAWINGS

Various exemplary embodiments of this invention will be described in detail, wherein like reference numerals refer to identical or similar components or steps, with reference to the following figures, wherein:

FIG. 1 illustrates an exemplary bird perch assembly with a feeder assembly attached thereto according to this subject disclosure.

FIG. 2 is a front view of the bird perch assembly with the feeder assembly attached thereto.

FIG. 3 depicts a side view of the bird perch assembly with the feeder assembly attached.

FIG. 4 shows a top view of the bird perch assembly with the feeder assembly attached.

FIG. 5 illustrates a bottom view of the bird perch assembly with the feeder assembly attached.

FIG. 6 depicts a front perspective view of the bird perch assembly.

FIG. 7 is a cross section illustration of section view taken at line A-A in FIG. 2.

FIG. 8 is a partial cross section illustration of section view taken at line B-B in FIG. 1.

FIG. 9 shows a front perspective view of the frame.

FIG. 10 depicts a top view of the frame.

FIG. 11 shows a bottom view of the frame.

FIG. 12 illustrates an exploded lower view of an end of the frame.

FIG. 13 depicts an exploded lower side view of an end of the frame.

FIG. 14 shows an exploded view of the upper portion of the frame with the hanger and attracting element.

FIGS. 15-16 illustrate various exploded views of the attracting element.

FIGS. 17-20 depict various views of the hanger.

FIG. 21 shows a front perspective view of the feeder assembly attached to the rod.

FIG. 22 shows a rear perspective view of the feeder assembly attached to the rod.

FIG. 23 depicts an exploded view of the feeder assembly.

FIGS. 24-25 illustrate various views of the feeder container.

FIGS. 26-28 show various views of the feeder cap.

FIG. 29 depicts a retainer attached to a rod.

FIG. 30 is a perspective view of a circular cage of the retainer.

FIG. 31 is a perspective view of a clip of the retainer.

### DETAILED DESCRIPTION

Particular embodiments of the present invention will now be described in greater detail with reference to the figures.

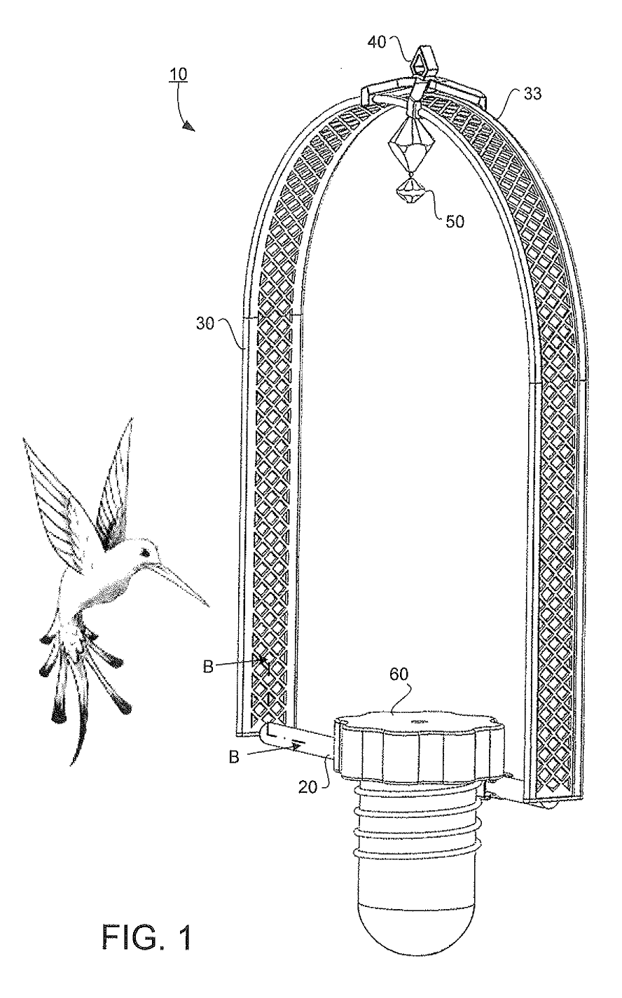

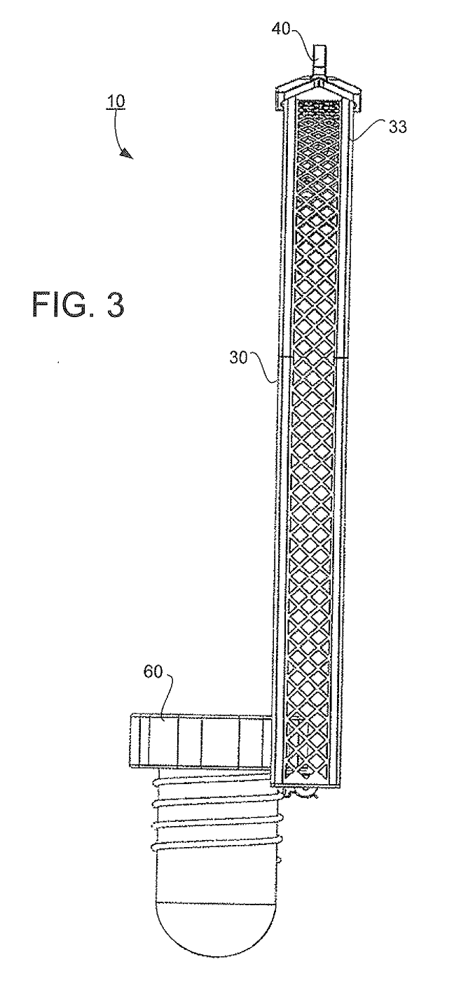

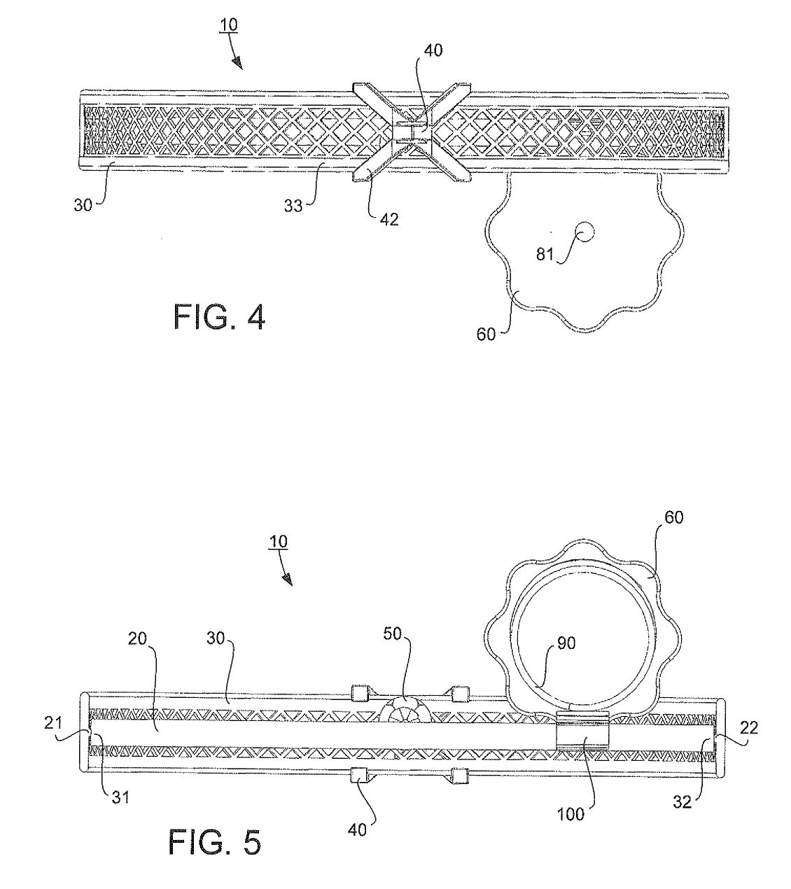

FIGS. 1-3 illustrate an exemplary swing or bird perch assembly 10 according to this subject disclosure. The bird perch assembly 10 includes an elongated rod 20 enclosed within an arch shape frame 30. As shown in top view in FIG. 4, a hanger 40 is fastened to an upper end of the frame 30. An attracting element 50 hangs from the upper end 32 of the frame 30 to draw birds to the perch assembly 10. A bird feeder assembly 60 is attached to the rod 20.

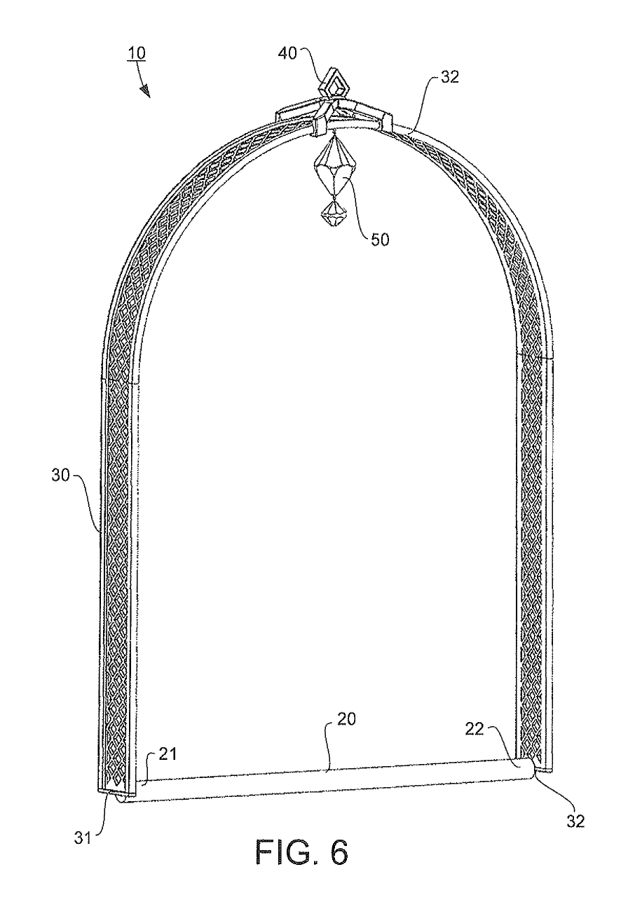

FIGS. 5-6 depict various views of the elongated rod 20 attached to the frame 30. Particularly, FIG. 5 shows a bottom view of the perch assembly 10 and FIG. 6 shows a front view of the perch assembly without the feeder assembly 60. The elongated rod 20 is fastened at a first end 21 to a first lower end 31 of the frame 30. A second end 22 of the elongated rod 20 is fastened to a second lower end 32 of the frame 30. The first and second ends 21, 22 of the elongated rod 20 may be fastened to the frame 30 in a variety of different ways.

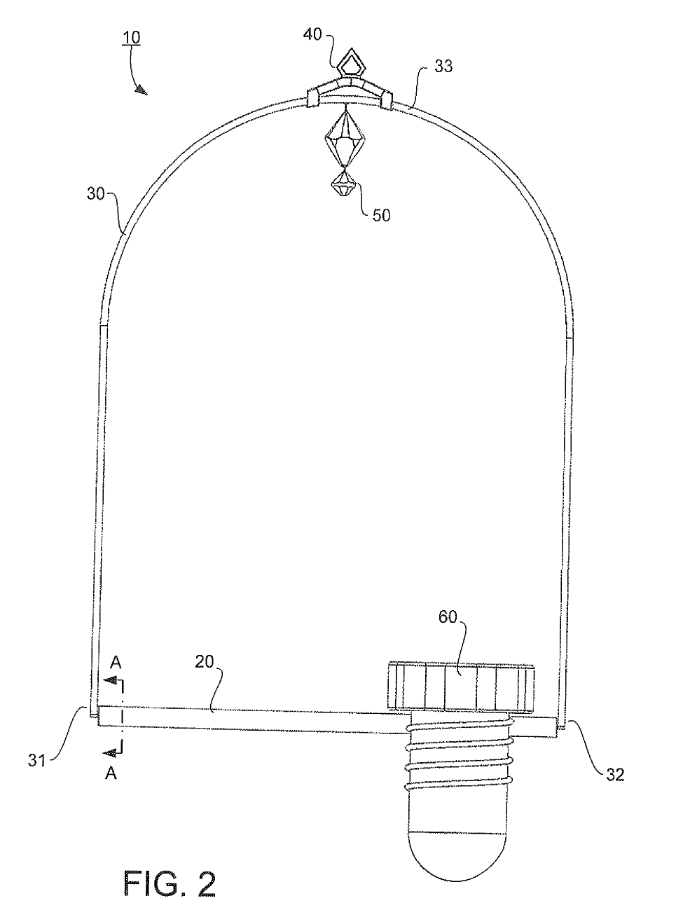

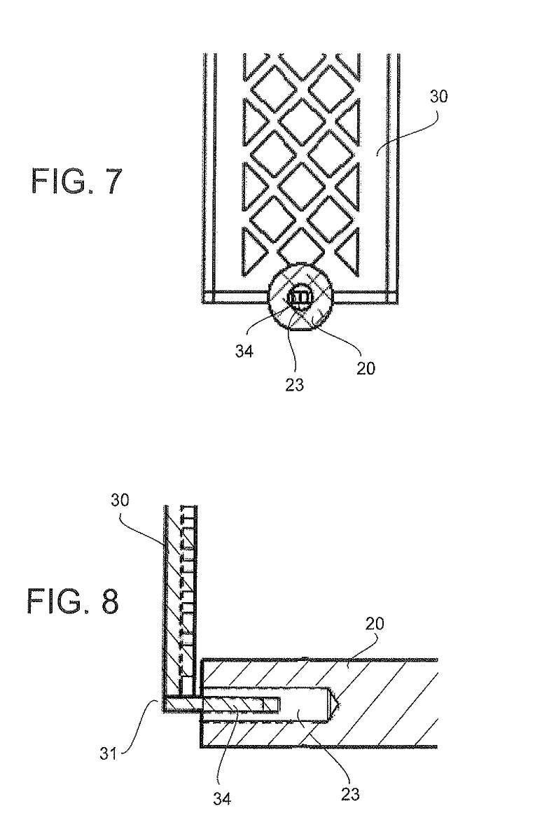

FIGS. 7-8 show one exemplary attachment that can be made between the elongated rod 20 and the frame 30. More specifically, FIG. 7 is a cross section illustration of section view taken at line A-A in FIG. 2, and FIG. 8 is a partial cross section illustration of section view taken at line B-B in FIG. 1. In each figure, the elongated rod 20 is shown including a hollow recess 23 countersunk into the first and second ends of the elongated rod 20. The hollow recess 23 is adapted to receive laterally extending support members 34. The laterally extending support members 34 extend inward from the first and second lower ends 31, 32 of the frame 30. In assembly, the extending support member 34 is positioned within the hollow recesses 23 in a secure manner.

It is to be understood that other suitable fasteners may be used, such as a different locking configuration, an adhesive and/or any other suitable fastening attachment mechanism according to this subject disclosure. According to one aspect of this subject disclosure, the rod 20 may be substantially rotationally secured to prevent rotation of the rod 20 while a bird is perched on it thereby making the perching and swinging process easier for the bird.

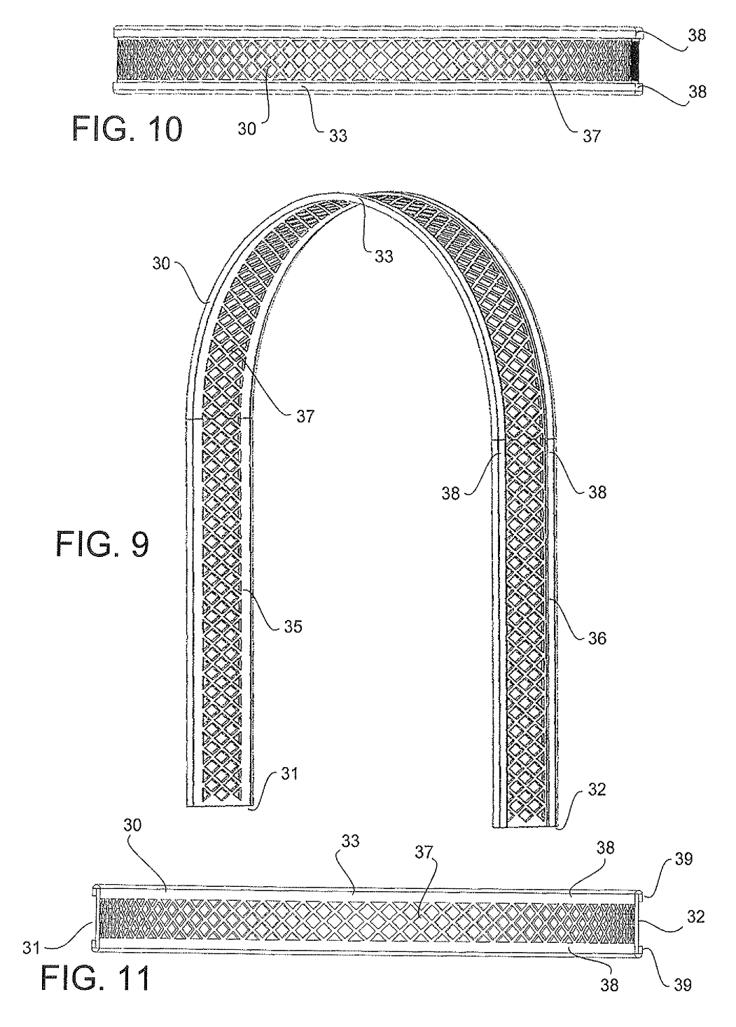

FIGS. 9-11 show various views of the arch shape frame 30. FIG. 9 shows a front perspective view of the frame 30. FIGS. 10 and 11 show a top and bottom view of the frame 30. The frame 30 is a single piece contiguous structure having an upper end 33 of the arch and a first leg 35 and a second leg 36 that extend downward from the upper end 33 of the frame 30.

The frame 30 includes a lattice structure 37 disposed between a pair of outer elongated rims 38 that border the frame 30 along its length. The advantage of the lattice structure 37 is to permit various birds to grab onto the perch assembly 10 about the frame 30 at the same time. That is, some birds may rest and swing on the elongated rod 20 while others may hang from the lattice structure 37 of the frame 30. It is to be understood that the design for the lattice structure 37 may take a variety of different shapes and sizes and configurations.

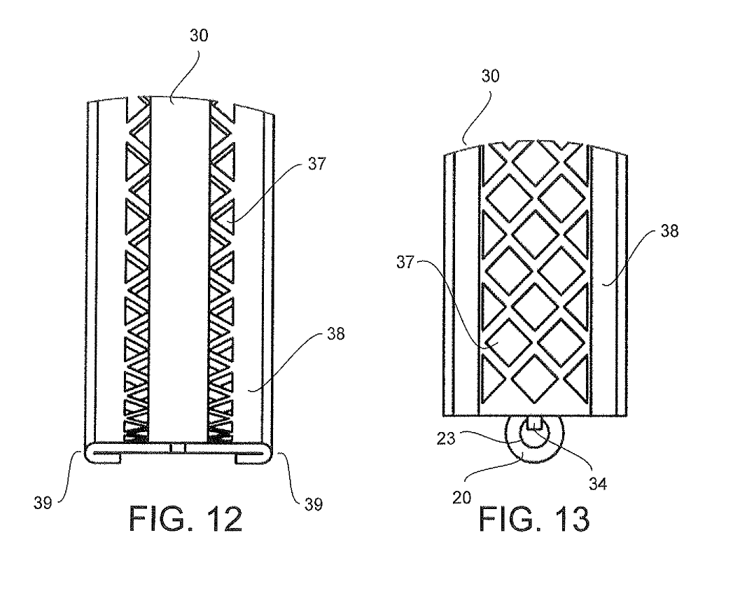

FIG. 12 shows an exemplary construction for the frame 30. As shown, the outer elongated rims 38 may have a fold 39 that can be folded back over onto itself to provide a smooth outer peripheral edge to the outer edges of the frame 30. As shown in FIGS. 12 and 13, the lattice structure 37 can take a variety of different aesthetic shapes and/or configurations to suitably allow various birds to support themselves on the lattice structure 37 of the frame 30.

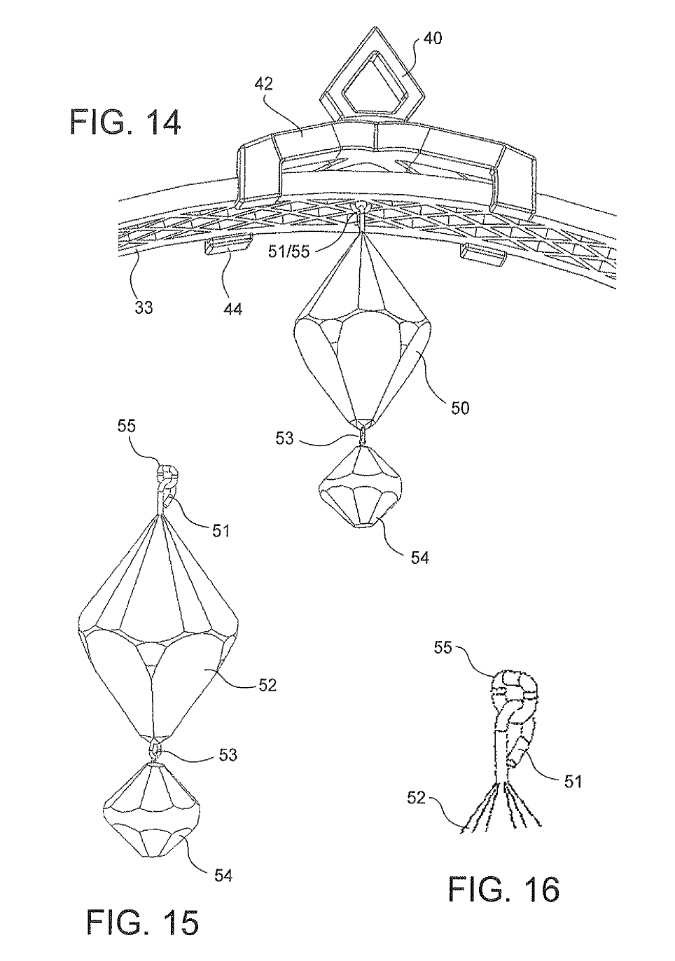

FIGS. 14-16 show an enlarged view of the hanger 40 and attracting element 50 attached to the upper end 33 of the frame 30. The attracting element 50 hangs downward and is attached by an upper link 51 and a hook 55 to the upper end 33 of the frame 30. The attracting element 50 may be configured in the shape of an iridescent jewel. As shown in this embodiment, the attracting element 50 includes a first larger jewel 52 attached by a lower link 53 to a smaller jewel 54.

The attracting element 50 may be a colorful blown glass piece such as an iridescent red glass element. The colorful element 50 may be made from a variety of different colors and shapes or sizes. Colors may be selected bright and to mimic various bright colored tubular flowers like yellow, orange and/or pink. Constructing the attracting element 50 to mimic bleeding hearts, impatiens, petunias, salvias, bee balm, columbine, canvas, viburnums, honeysuckles and many other flowers in shape, size and/or color will attract a variety of different hummingbirds.

The attracting element 50 may include a Ultra-Violet (UV) or other protective coating and/or may be made from a durable, polycarbonate to prevent fading from extended UV exposure and to maintain the sharp brilliant iridescent color of the coating. The attracting element 50 may be made from a crystal-clear, eco-friendly recycled piece of glass, polymer or any suitable material according to this subject disclosure.

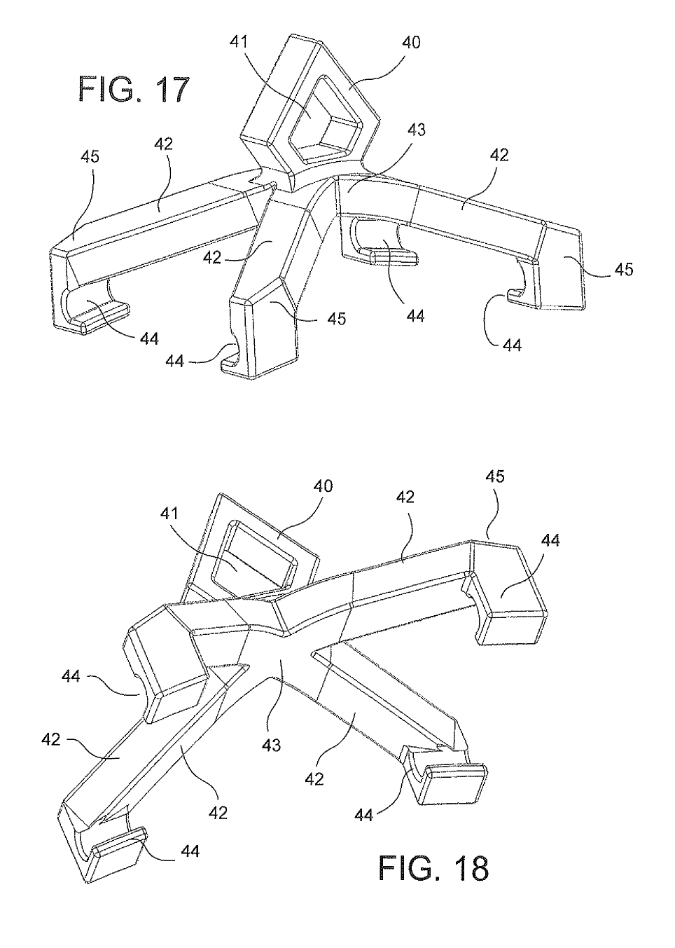

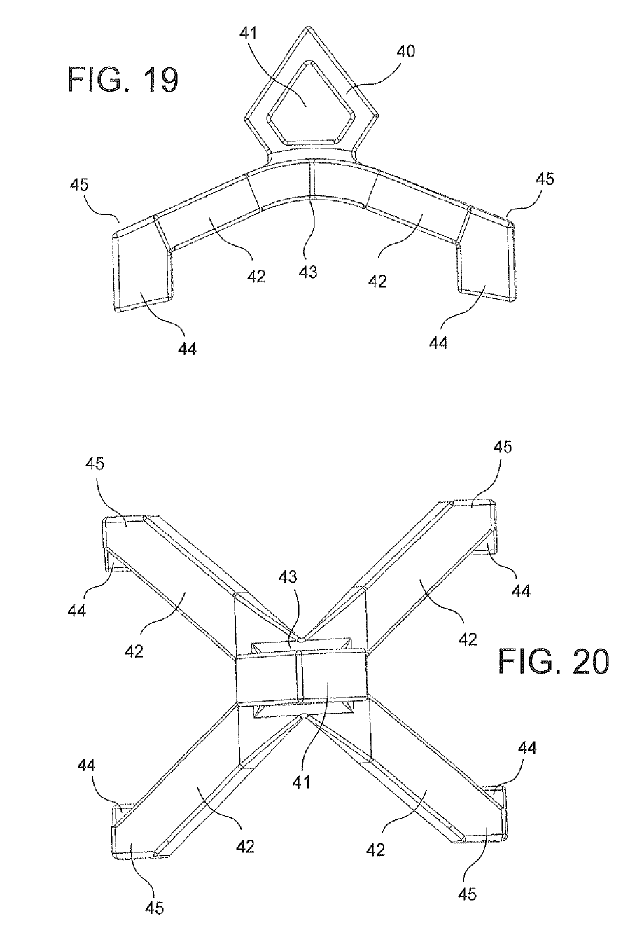

FIGS. 17-20 illustrate an exemplary embodiment for the hanger 40. As shown, the hanger 40 includes an enclosed aperture 41 in an upper hook through which another hanger may be secured to attach the hanger 40 to another adjacent element such as a limb of a tree or the like. It is to be understood that the enclosed aperture may be an open hook and/or various other configurations capable of providing an opening for hanging to another element.

The hanger 40 is shown including four arms 42 that extend outward from a common base 43 of the hanger 40 below the enclosed aperture 41. The arms 42 extend outward from the base 43 outward to a distance that is substantial equidistant to the elongated rim 38 on the frame 30. Various hooks 44 are formed at distal ends 45 of the arms 42. The hooks 44 extend downward and inward from the distal ends of the arms 42 in a hook shape adapted to clamp onto the elongated rim 38 of the frame 30. It is to be understood that various constructions are possible for the hanger 40 capable of including one or more extending arm(s) having hook portions that are adapted to clasp onto the outer edges of the lattice structure 37.

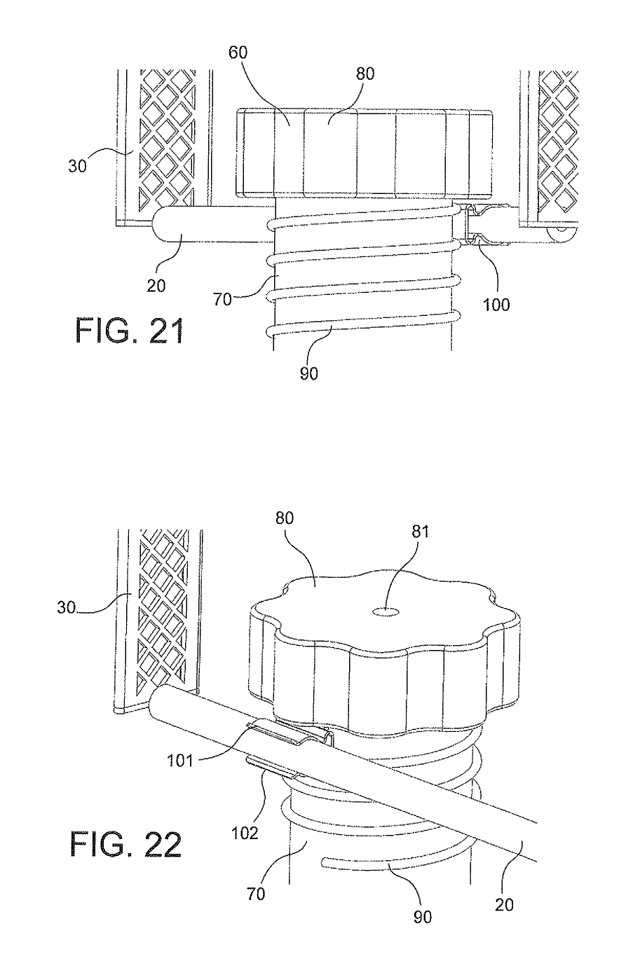

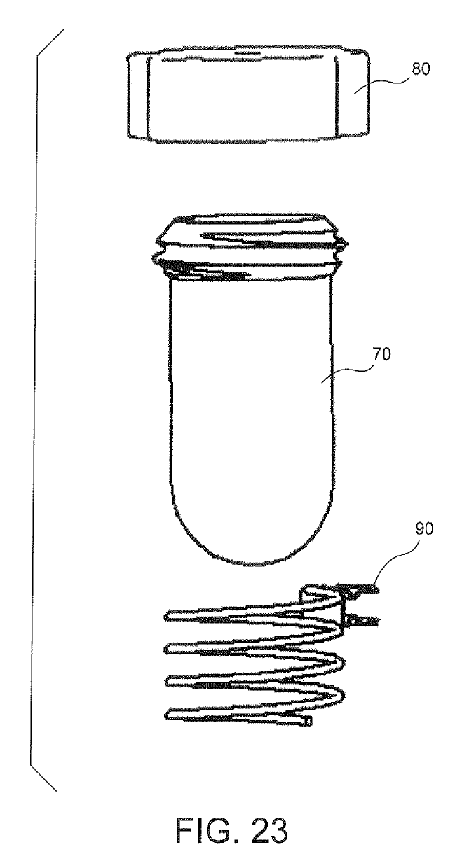

FIGS. 21-22 show and exemplary feeder assembly 60 attached to the elongated rod 20 according to this subject disclosure. As shown exploded in FIG. 23, the feeder assembly 60 includes a feeder container 70, a cap 80, and a retainer 90. In position, the container 70 is secured by the retainer 90 to the elongated rod 20 in an upright position.

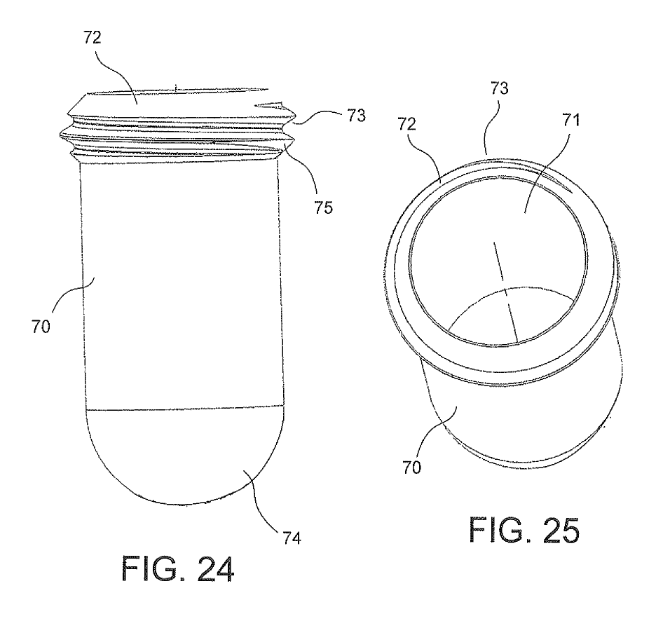

FIGS. 24-25 depict the container 70 having an internal cavity 71 including an open top 72 and a closed bottom 74. The container 70 includes various fasteners 73 disposed at the upper end near the open top 72. The container 70 has an elongated circular body with a flared out neck portion 75 onto which the fasteners 73 are disposed. In use, the circular cage 91 of the retainer 90 rests against the flared out neck portion 75 of the container 70.

It is to be understood that the container 70 may take a variety of different sizes and/or shapes according to this subject disclosure. Although shown as a cylindrical tubular shape, the container 70 can be constructed of any shape, such as in a shape to represent a flower or other item or design suitable for attracting a bird to the feeder assembly 60.

The feeder container 70 may be made from crystal-clear, eco-friendly recycled glass with a UV coating. The feeder container 70 may take a variety of different sizes, colors and/or shapes, such as the cylindrical shape shown herein or may take on the shapes of a flower, such as a long tubular flower in which the extended tubular portion including a container space or cavity 71 for holding a feeding substance.

The container 70 may be used for a variety of different purposes. In one instance, the container 70 can be used as mentioned above as a feeder for various edible substances. Alternatively, the container could be used to place various items such as twigs, leaves or the like for the various birds to retrieve items from within its cavity to build a nest or the like.

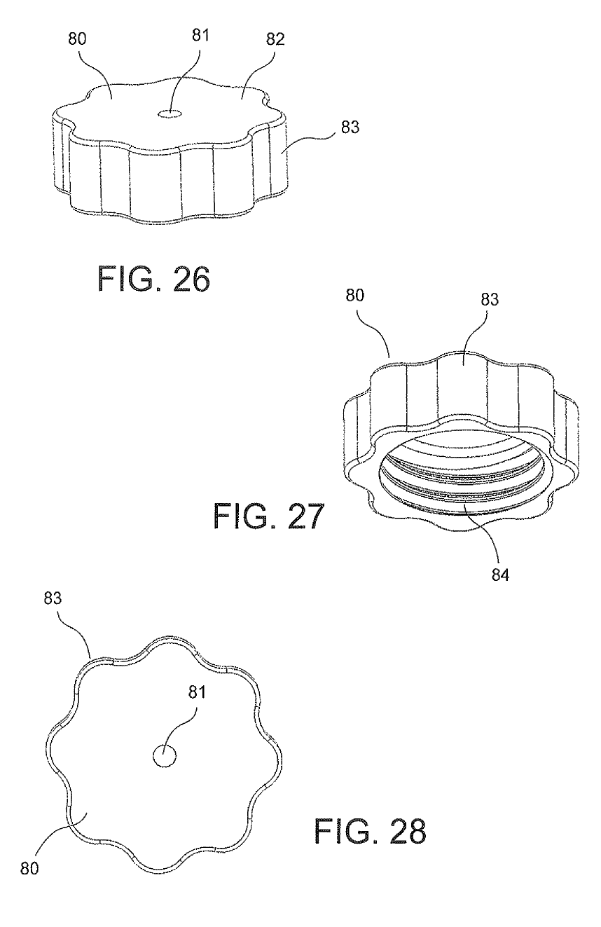

FIGS. 26-28 depict an exemplary illustration of the feeder cap 80. The cap includes an aperture 81 provided in a top 82 of the cap 80. The aperture 81 may be adapted to receive a beak of a bird, such as the long beak of a hummingbird. Various gripping protrusions 83 may be provided on an outer surface of the cap to assist in the grasping of the cap 80. As shown in FIG. 28, the protrusions 83 may be shaped to mimic a flower or other flowers attractive to a bird, such as petals on a plant of a tubular flower which is attractive to a hummingbird. Alternatively, no protrusion may be provided in the shape of the cap 80. As with the container 70, the cap 80 may take a variety of different sizes and/or shapes suitable to closing off the cavity within the container 70 are contemplated within the scope of this subject disclosure.

As shown in FIG. 27, various female fasteners 84 are provided on an inner surface of the cap 80. The female fasteners 84 are adapted to mate with and to be secured to the male fasteners 73 disposed on an outside surface of the container 70. It is to be understood that any number of different fasteners may be used to secure the cap 80 to the container 70, such as a snap locking mechanism connection and/or any other suitable connection for securing the cap 80 to the container 70.

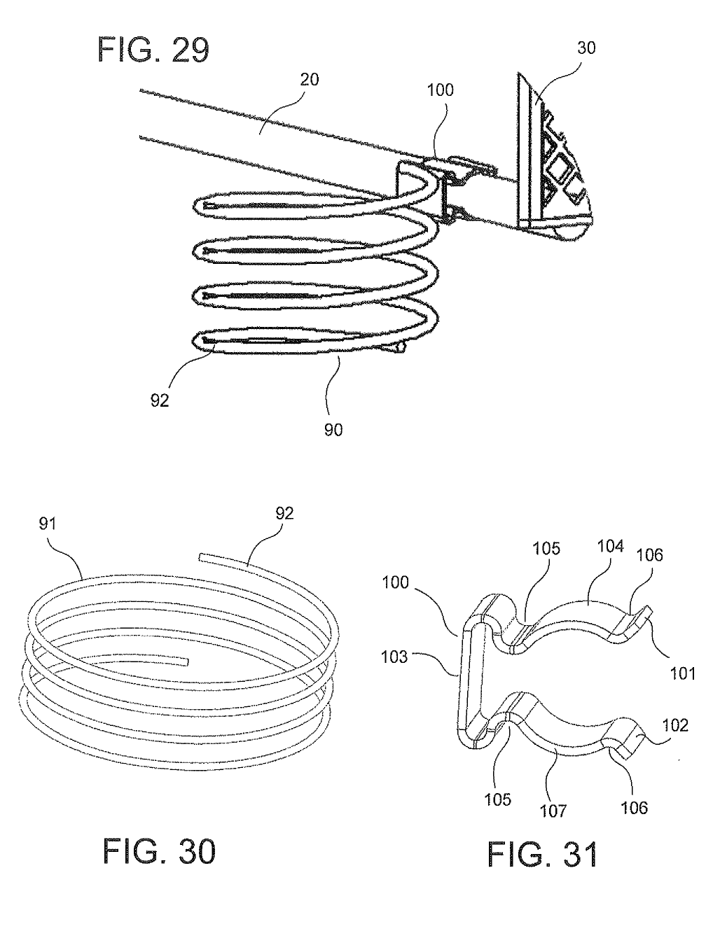

FIG. 29 shows the container retainer 90 attached to the elongated rod 20. It is to be understood that the retainer 90 may take a number of different sizes and/or shapes suitable for securing the container 70 to the perching assembly 10 as contemplated within the scope of this subject disclosure. That is, the container retainer may be constructed to attach to the various component parts of the perch assembly 10, such as the frame, the holder, the attractant element and/or any other component in the perch assembly 10.

For exemplary purposes, the retainer 90 is shown including a spiral cylindrical cage 91 and a clip 100. The spiral cylindrical cage 91 is attached to the clip 100 such that the spiral cylindrical cage 91 is positioned in a specific predetermined direction to orient the container 70, such as in a vertical orientation as shown in FIG. 1.

The spiral cylindrical cage 91 is adapted to receive the outer surface of the container 70 within its inner formed diameter. The spiral cylindrical cage 91 may be formed by an elongated tubular wire 92 having an inner circular diameter substantially equal to an outer surface of the container 70. The spiral cylindrical cage 91 is provided to secure the container 70 in an upright position. It is to be understood that any holder construction and/or suitable holding structure may be used in place of the spiral cylindrical cage 91. For example, a single element such as a strap or a band may be used and/or any other shape capable of securing the container 70 to the perching assembly 10.

FIG. 31 shows an exemplary construction for the clip 100. The clip 100 has a contoured fork construction. The clip 100 has a first leg 101 and a second leg 102 connected by a clip base 103. The first leg 101 extends from the base 103 with a contour having a partial curve 104 adapted to fit around a portion of the rod 20. The first leg 101 extends from the base 103 outward and inwardly into a first inward pinched neck 106 adapted to be secured against the rod 20 on a first side of the first partial curve 104. The first leg 101 further includes a second pinched neck 106 portion adapted to be secured against the rod 20 on a second side of the first partial curve 104.

The second leg 102 extends from the base 103 with a contour having a partial curve 107 adapted to fit around another portion of the rod 20. The second leg 102 extends from the base 103 outward and inwardly into another first inward pinched neck 105 adapted to be secured against the rod 20 on a first side of the first partial curve 107. The second leg 107 further includes a second pinched neck 106 portion adapted to be secured against the rod 20 on a second side of the second partial curve 107.

The perch assembly 10 may be hung in an open area near hummingbird feeders or nectar-rich flowers for hummingbirds, since those are the areas where dominant birds, such as hummingbirds, will most likely be attracted to a swinging perch to monitor their food and territory. Other placement options may include hanging the perch assembly 10 under a mister in a shady area to provide a convenient perch for bathing hummingbirds and/or placing the swing near a hummingbird house or nesting area so parent birds can stay close to their young and fledgling chicks and to have a safe perch when learning to fly. As mentioned previously, hummingbirds are territorial and tend to chase competing hummingbirds away from the best feeding areas and nesting sites. As such, the perch assembly 10 provides a ready-made swinging perch for the birds to use when monitoring their favorite territories. The advantage of providing the perch assembly is to encourage hummingbirds to come back to the same spot so that birdwatchers can enjoy their company and watch them closely and carefully.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

1-20. (canceled)

21. A feeder assembly for a bird perch comprising:
a feeding container having a closed end and an open end;
a cap removably attached to the open end of the feeding container, and having an aperture adapted to receive a beak of a bird; and
a fastener adapted to secure the feeding container to the bird perch in a predetermined position.

22. The feeder assembly recited in claim 21, wherein the fastener comprises:
a retainer clip; and
a holder adapted to secure the feeding container to the perch in the predetermined position.

23. The feeder assembly recited in claim 22, wherein the retainer clip has a fork construction comprising:
a first leg; and
a second leg connected by a clip base.

24. The feeder assembly recited in claim 23, wherein the first leg extends from the base with a contour having a first partial curve and the the second leg extends from the base with another contour having a second partial curve.

25. The feeder assembly recited in claim 24, wherein the curves are configured to pinch and be secured against the bird perch.

26. The feeder assembly recited in claim 22, wherein the holder wraps substantially around the feeding container.

27. The feeder assembly recited in claim 21, wherein the cap comprises an attractant element.

28. The feeder assembly recited in claim 27, wherein the attractant element is the cap configured as a flower.

29. The feeder assembly recited in claim 27, wherein the attractant element is a jewel element with a UV coating.

30. The feeder assembly recited in claim 21, configured to be secured to a bird perch assembly comprising:
an elongated rod;
a frame configured as a u-shaped structure having a first end attached to a first end of the elongated rod and a second end attached to a second end of the elongated rod; and
a hanger attached to the frame having an upper hook for hanging.

31. A feeder assembly for a bird perch comprising:
a feeding container having a closed end and an open end;
a cap removably attached to the open end of the feeding container, the cap having an aperture adapted to receive a beak of a bird; and
a fastener adapted to secure the feeding container to the bird perch in a predetermined position, the fastener further comprising:
a retainer clip; and
a holder attached to the retainer clip, and adapted to secure the feeding container to the perch in the predetermined position.

32. The feeder assembly recited in claim 31, wherein the retainer clip has a fork construction comprising:
a first leg; and
a second leg connected by a clip base.

33. The feeder assembly recited in claim 31, wherein the cap is configured as a flower.

34. The feeder assembly recited in claim 31, wherein the cap is configured as an attractant jewel element.

35. The feeder assembly recited in claim 31, configured to be secured to a bird perch assembly comprising:
an elongated rod;
a frame configured as an u-shaped lattice structure having a first end attached to a first end of the elongated rod and a second end attached to a second end of the elongated rod; and
a hanger attached to the frame having an upper hook for hanging.

36. A feeder assembly for a bird perch comprising:
a feeding container having a closed end and an open end;
a cap removably attached to the open end of the feeding container, the cap having an aperture adapted to receive a beak of a bird; and
a fastener adapted to secure the feeding container to an elongated rod on the bird perch, the fastener further comprising:
a retainer clip having a fork construction and configured to be secured to the elongated rod; and
a holder attached to the retainer clip and adapted to secure the feeding container to the elongated rod in a predetermined position.

37. The feeder assembly recited in claim 36, wherein the retainer clip further comprises:
a first leg; and
a second leg connected by a clip base.

38. The feeder assembly recited in claim 36, wherein the cap is an attractant element configured as a flower.

39. The feeder assembly recited in claim 38, wherein the cap is an attractant jewel element.

40. The feeder assembly recited in claim 36, configured to be secured to a bird perch assembly comprising:
the elongated rod;
a frame configured as an u-shaped lattice structure having a first end attached to a first end of the elongated rod, and a second end attached to a second end of the elongated rod; and
a hanger attached to the frame for hanging.
